(19) United States
(12) Patent Application Publication
(10) Pub. No.: US 2011/0296741 A1
(43) Pub. Date: Dec. 8, 2011

(54) BIODIESEL CANDLE FORMULA AND DELIVERY SYSTEM

(76) Inventors: Kari HEABERLIN, Redlands, CA (US); Duwaine Edward DORRIES, Corona, CA (US); Jarrod KUHN, Fountain Valley, CA (US); Ron RILEY, Germantown, TN (US); Richard Eugene MILLER, Murrieta, CA (US)

(21) Appl. No.: 12/964,550

(22) Filed: Dec. 9, 2010

Related U.S. Application Data
(60) Provisional application No. 61/285,464, filed on Dec. 10, 2009.

(51) Int. Cl. C11C 5/00; F23D 3/16

(52) U.S. Cl. 44/275; 431/288

(57) ABSTRACT

A biodiesel candle formed of a wick and a fuel composition having at least one fatty acid methyl ester, at least one antioxidant, and at least one chelating agent. The biodiesel candle may further include at least one monobasic ester, at least one secondary alcohol, and/or at least one additional fuel, such as mineral oil. The resulting candle features a reduced production of incombustible free radical polymers during use.

### CROSS-REFERENCE TO RELATED APPLICATIONS

This application claims the benefit of U.S. Provisional Application No. 61/285,464, filed on Dec. 10, 2009, the entire contents of which are expressly incorporated by reference.

### STATEMENT RE: FEDERALLY SPONSORED RESEARCH/DEVELOPMENT

Not Applicable

### BACKGROUND

1. Field of the Invention

The present invention relates to a biodiesel-based candle fuel and candles formed from such fuel.

2. Description of the Related Art

Candles are light sources typically constructed from a solid block of fuel and an embedded wick. The fuel is commonly made from paraffin, but can also be made from tallow, beeswax, soy, and other plant waxes. Recently there has been an effort to produce candles made from more natural, ecologically friendly materials, such as soy or other biodiesels. However, use of such materials can lead to spoiling of the candle during storage, as well as the production of harmful or unwanted byproducts during the combustion of the fuel.

### BRIEF SUMMARY

The present invention relates to a biodiesel-based candle fuel and candles formed of such fuel.

In one embodiment of the present invention, a candle is formed of a composition having at least one fatty acid methyl ester, at least one antioxidant, and at least one chelating agent. In this embodiment, the candle may further include a wick. If a wick is present, it may be made from, for example, cotton or fiberglass.

The antioxidant of this embodiment may be a tert-butylated phenol, a polyphenol, a tocotrienol, an α-tocophenol, a thiol, a carotene, or an ubiquinol. Furthermore, the chelating agent in this embodiment may be an organic acid, for example, either citric acid or malonic acid. Additionally, the candle of this embodiment may further include at least one monobasic ester. Another embodiment of the present invention relates to a candle formed of a composition having at least one fatty acid methyl ester and at least one monobasic ester. In this embodiment, the monobasic ester may be present in the composition in an amount ranging from about 15% to about 35% by weight. The candle of this embodiment may further include at least one antioxidant. If an antioxidant is included, the monobasic ester may be present in the composition in an amount from about 2% to about 10% by weight.

Another embodiment of the present invention relates to a candle formed of a composition having at least one fatty acid methyl ester and a secondary alcohol. In this embodiment, the secondary alcohol may be, for example, either ethanol or isopropanol. The candle of this embodiment may further include a fiberglass wick. In this embodiment, the fatty acid methyl ester may be present in the composition in an amount from about 90% to about 99% by weight. Additional fuels may be utilized in the present invention, for example, mineral oil.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a candle having a fuel disposed within a container and a wick protruding from the container.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

As used herein, the term “antioxidant” refers to a molecule or chemical compound capable of removing free radicals generated from decomposition of fatty acid methyl esters (FAMEs).

As used herein, the term “free radical” refers to any atom with at least one unpaired electron in the outermost shell.

The present invention relates to a biodiesel-based candle fuel 10 and candles 12 formed of such fuel 10.

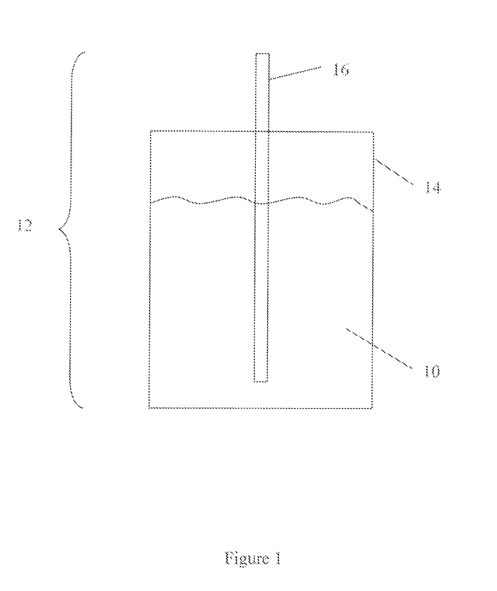

In one embodiment of the present invention, a candle 12 is formed of a fuel 10 having fatty acid methyl esters (FAME) and a standard wick delivery system of cotton or a thin, tightly braided fiberglass wick material. The fuel 10 may be disposed within a container 14 with a wick 16, as shown in FIG. 1. The fuel 10 is blended with an antioxidant to prevent methyl ester free radical polymerization caused by combustion of the FAME. In the absence of an antioxidant, as is the case with the prior art, the FAMEs break apart at their ester centers and create molecule fragments having free radicals within the flame and partially decomposed fuel of the candle during its combustion. These molecule fragments then join together to form incombustible solids, much like charcoal, along the wick 16 of the candle 12. Additionally, these molecule fragments can escape from the delivery system as a heavy, partially decomposed liquid.

In an effort to prevent the formation of free radicals when burning a candle 12 having a FAME-based fuel, the fuel 10 includes an antioxidant. Examples of suitable antioxidants include tert-butylated phenols, polyphenols, tocotrienols, α-tocophenols, thiols, carotenes, and ubiquinols. Due to the structural properties of an antioxidant, free radicals can bind to the double bonded carbons found in its conjugated rings, thereby stabilizing the decomposition of the FAMEs.

Furthermore, a chelating agent can be added to the fuel 10 to further stabilize the reaction by forming chelates with the free radicals produced, thereby increasing the combustibility of the insoluble polymers formed during oxidation. Chelation is a process that prevents precipitation of molecules in solution, which may result from interactions between FAMEs, free radicals, and antioxidants during combustion. Examples of chelating agents that may be used are citric acid, malonic acid, and certain amino acids.

Another embodiment of the present invention relates to a candle fuel formula that utilizes the co-solvent properties of a monobasic ester in addition to, or as a substitute for, the antioxidant of the first embodiment. If the monobasic ester is used without an antioxidant, however, incombustible free radical intermediates will still form within the wick 16, although to a lesser degree. When a monobasic ester is used in conjunction with an antioxidant it will diminish the reducing, ability of the antioxidant. As such, the monobasic ester may be included in the composition in an amount ranging from about 15% to about 35% by weight in the absence of an antioxidant and in an amount from about 2% to about 10% by weight in the presence of an antioxidant.

Another embodiment of the present invention relates to a biodiesel candle fuel 10 having at least one fatty acid methyl ester and a secondary alcohol. In this embodiment, the secondary alcohol may be, for example, either ethanol or isopropanol. The candle 12 of this embodiment may further include a fiberglass wick 16. In this embodiment, the fatty acid methyl ester may be present in the composition in an amount from about 90% to about 99% by weight and the secondary alcohol may be present in an amount from about 1% to about 10%.

In summary, the addition of the antioxidant to the candle fuel as envisioned by the present invention can serve to prevent spoiling of the candle 12 during storage by reducing oxidation of the biodiesel fuel caused by high temperatures and exposure to air, while also improving the combustion of the fuel 10 by removing the incombustible, free radical polymers formed therein and enhancing the flame temperature by increasing the oxygen content. Additional fuels may be utilized in the formation of the candle. For example, mineral oil may be utilized in addition to the fatty acid methyl ester. In one particular example, the mineral oil is present in the composition in an amount ranging from about 5% to about 10% by weight.

The above description is given by way of example, and not limitation. Given the above disclosure, one skilled in the art could devise variations that are within the scope and spirit of the invention disclosed herein, including the use of various biodiesel fuels, antioxidants, and candle forming techniques. Further, the various features of the embodiments disclosed herein can be used alone, or in varying combinations with each other and are not intended to he limited to the specific combination described herein. Thus, the scope of the claims is not to be limited by the illustrated embodiments.

What is claimed is:

1. A candle formed of a composition comprising at least one fatty acid methyl ester, at least one antioxidant, and at least one chelating agent.

2. The candle of claim 1, wherein the candle further comprises a wick.

3. The candle of claim 2, wherein the wick is made from either cotton or fiberglass.

4. The candle of claim 1, wherein the at least one antioxidant is selected from the group consisting of a tert-butylated phenol, a polyphenol, a tocotrienol, an α-tocophenol, a thiol, a carotene, and an ubiquinol.

5. The candle of claim 1, wherein the chelating agent is an organic acid.

6. The candle of claim 5, wherein the organic acid is either citric acid or malonic acid.

7. The candle of claim 1, wherein the candle further comprises at least one monobasic ester.

8. The candle of claim 1, wherein the candle further comprises mineral oil.

9. The candle of claim 9, wherein the mineral oil is present in an amount from about 5% to about 10% by weight.

10. A candle formed of a composition comprising at least one fatty acid methyl ester and at least one monobasic ester.

11. The candle of claim 10, wherein the monobasic ester is present in the composition in an amount from about 15% to about 35% by weight.

12. The candle of claim 10, wherein the composition further comprises at least one antioxidant.

13. The candle of claim 12, wherein the monobasic ester is present in the composition in an amount from about 2% to about 10% by weight.

14. The candle of claim 10, wherein the candle further comprises mineral oil.

15. The candle of claim 14, wherein the mineral oil is present in an amount from about 5% to about 10% by weight.

16. A candle formed of a composition comprising at least one fatty acid methyl ester and a secondary alcohol.

17. The candle of claim 16, wherein the secondary alcohol is either ethanol or isopropanol.

18. The candle of claim 16, wherein the candle further comprises a fiberglass wick.

19. The candle of claim 16, wherein the fatty acid methyl ester is present in the composition in an amount from about 90% to about 99% by weight.
